(19) United States
(12) Patent Application Publication
(10) Pub. No.: US 2023/0389082 A1
(43) Pub. Date: Nov. 30, 2023

(54) TERMINAL

(71) Applicant: NTT DOCOMO, INC., Tokyo (JP)

(72) Inventors: Haruhi Echigo, Tokyo (JP); Daisuke Kurita, Tokyo (JP); Hiroki Harada, Tokyo (JP)

(73) Assignee: NTT DOCOMO, INC., Tokyo (JP)

(21) Appl. No.: 18/032,069

(22) PCT Filed: Oct. 15, 2020
(86) PCT No.: PCT/JP2020/038999

§ 371 Date: Apr. 14, 2023

(51) Int. Cl. H04W 74/08; H04W 72/1268; H04W 74/00; H04L 5/00

(52) U.S. Cl. CPC H04W 74/0833; H04W 72/1268; H04W 74/006; H04L 5/0012

(57) ABSTRACT

A terminal includes: a transmission unit that transmits a random access preamble as the first message in a random access channel procedure; and a reception unit that receives a response message to the first message as the second message in the random access channel procedure; wherein the transmission unit transmits a third message via a physical uplink shared channel in the random access channel procedure, after receiving the second message, and the transmission unit performs a repetitive transmission of the third message.

### TECHNICAL FIELD

The disclosure relates to a terminal that performs radio communication, in particular, a terminal that transmits messages over a physical uplink shared channel in a random access channel procedure.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

Release 15 and Release 16 (NR) of 3GPP specify the operation of a band that includes multiple frequency ranges, specifically FR1 (410 MHz to 7.125 GHz) and FR2 (24.25 GHz to 52.6 GHz).

In 3GPP Release 17, coverage enhancement is discussed in FR1 and FR2 (Non-Patent Literature 1). Along with this, improvement in channel quality such as PUSCH (Physical Uplink Shared Channel), PUSCH (Physical Uplink Shared Channel), PDCCH (Physical Downlink Control Channel), and PUCCH (Physical Uplink Control Channel) is desirable.

### CITATION LIST

### Non-Patent Literature

Non-Patent Literature 1: “New SID on NR coverage enhancement,” RP-193240, 3GPP TSG RAN Meeting #86, 3GPP, December 2019

### SUMMARY OF INVENTION

Against this background, the inventors focused on the message (Msg3) used in the Random Access Channel (RACH) procedure as a message transmitted via PUSCH. After careful consideration, the inventors found a way to improve the channel quality of PUSCH used to transmit such messages (Msg3).

Therefore, the following disclosure has been made in view of these circumstances, and the purpose of the disclosure is to provide terminals capable of improving channel quality.

The disclosure is summarized as a terminal comprising: a transmission unit that transmits a random access preamble as the first message in a random access channel procedure; and a reception unit that receives a response message to the first message as the second message in the random access channel procedure; wherein the transmission unit transmits a third message via a physical uplink shared channel in the random access channel procedure, after receiving the second message, and the transmission unit performs a repetitive transmission of the third message.

The disclosure is summarized as a terminal comprising: a transmission unit that transmits a random access preamble as a first message in a random access channel procedure; and a reception unit that receives a response message to the first message as a second message in the random access channel procedure; wherein the transmission unit transmits a third message via a physical uplink shared channel in the random access channel procedure, after receiving the second message, the reception unit receives two or more channel state information reference signals, after receiving the second message, and the transmission unit transmits the third message based on a channel state information reference signal selected from the two or more channel state information reference signals.

The disclosure is summarized as a terminal comprising: a transmission unit that transmits a random access preamble as a first message in a random access channel procedure; and a reception unit receives a response message to the first message as a second message in the random access channel procedure; wherein a transmission unit transmits a third message via a physical uplink shared channel in the random access channel procedure, after receiving the second message, the reception unit performs a repetitive reception of the second message, and the transmission unit transmits the third message based on the second message selected from the second messages received in the repetitive reception.

### BRIEF DESCRIPTION OF DRAWINGS

FIG. 1 is an overall schematic diagram of radio communication system 10.

FIG. 2 is a diagram showing the frequency range used in radio communication system 10.

FIG. 3 is a diagram showing an example configuration of the radio frame, subframe and slot used in radio communication system 10.

FIG. 4 is a functional block configuration diagram of the UE 200.

FIG. 5 is a diagram to illustrate the RACH procedure.

FIG. 6 is a diagram to illustrate the RACH procedure.

FIG. 7 is a diagram to illustrate the method of repetitive transmission.

FIG. 8 is a diagram showing RAR (Random Access Response).

FIG. 9 is a diagram showing frequency hopping.

FIG. 10 is a diagram for explaining the beam pattern according to Modification Example 1.

FIG. 11 is a diagram for explaining the RACH procedure according to Modification Example 1.

FIG. 12 is a diagram for explaining the RACH procedure according to Modification Example 1.

FIG. 13 is a diagram for explaining the RACH procedure according to Modification Example 1.

FIG. 14 is a diagram for explaining the RACH procedure according to Modification Example 1.

FIG. 15 is a diagram showing an example of the hardware configuration of the UE 200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### Embodiment

(1) Overall Schematic Configuration of the Radio Communication System

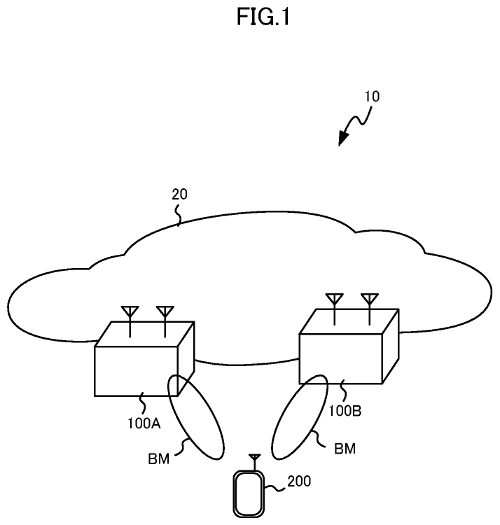

FIG. 1 is the overall schematic configuration of a radio communication system 10 according to the embodiment. The radio communication system 10 is a radio communication system according to 5G New Radio (NR) and includes the Next Generation-Radio Access Network 20 (NG-RAN 20), and Terminal 200 (herein below referred to as UE 200).

The radio communication system 10 may be a radio communication system according to a scheme called Beyond 5G, 5G Evolution or 6 G.

The NG-RAN 20 includes a radio base station 100A (herein below referred to as gNB 100A) and a radio base station 100B (herein below referred to as gNB 100B). The specific configuration of the radio communication system 10 including the number of gNBs and UEs is not limited to the example shown in FIG. 1.

The NG-RAN 20 actually contains multiple NG-RAN nodes, specifically gNBs (or ng-eNBs), and is connected to a core network (5GC, not shown) according to 5G. Note that the NG-RAN 20 and 5GCs may simply be described as a network.

The gNB 100A and gNB 100B are radio base stations in accordance with 5G and perform radio communication in accordance with the UE 200 and 5G. The gNB 100A, gNB 100B and UE 200 are capable of supporting Massive MIMO (Multiple-Input Multiple-Output) which generates a more directional beam BM by controlling radio signals transmitted from multiple antenna elements, carrier aggregation (CA) which uses multiple component carriers (CCs) bundled together, and dual connectivity (DC) which communicates with two or more transport blocks simultaneously between the UE and each of the two NG-RAN nodes.

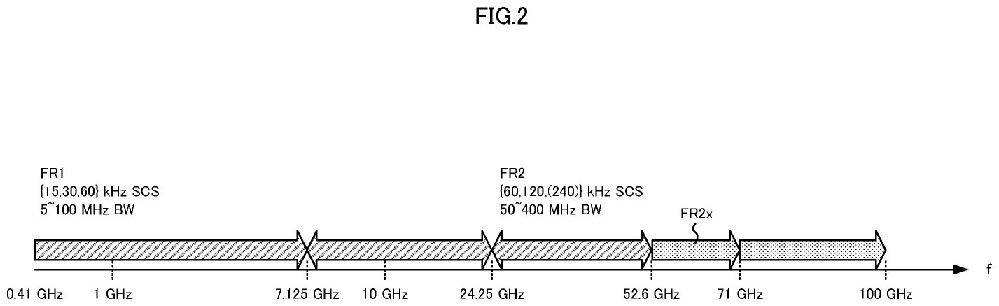

The radio communication system 10 also supports multiple frequency ranges (FRs). FIG. 2 shows the frequency ranges used in radio communication system 10.

As shown in FIG. 2, radio communication system 10 corresponds to FR1 and FR2. The frequency bands of each FR are as follows:
FR 1: 410 MHz to 7.125 GHz
FR 2: 24.25 GHz to 52.6 GHz

FR 1 uses sub-carrier spacing (SCS) of 15, 30 or 60 kHz and may use a bandwidth (BW) of 5˜100 MHz. FR 2 is a higher frequency than FR 1 and an SCS of 60 or 120 kHz (240 kHz may be included) may be used and a bandwidth (BW) of 50˜400 MHz may be used.

SCS may be interpreted as numerology. Numerology is defined in 3GPP TS 38.300 and corresponds to one subcarrier interval in the frequency domain.

In addition, the radio communication system 10 will support higher frequency bands than the FR2. Specifically, radio communication system 10 will support frequencies above 52.6 GHz and up to 114.25 GHz. Such high frequency bands may be referred to as “FR 2 x” for convenience.

To solve such problems, Cyclic Prefix-Orthologous Frequency Division Multiplexing (CP-OFDM)/Discrete Fourier Transform-Spread (DFT-S-OFDM) with larger Sub-Carrier Spacing (SCS) may be applied when using bands above 52.6 GHz.

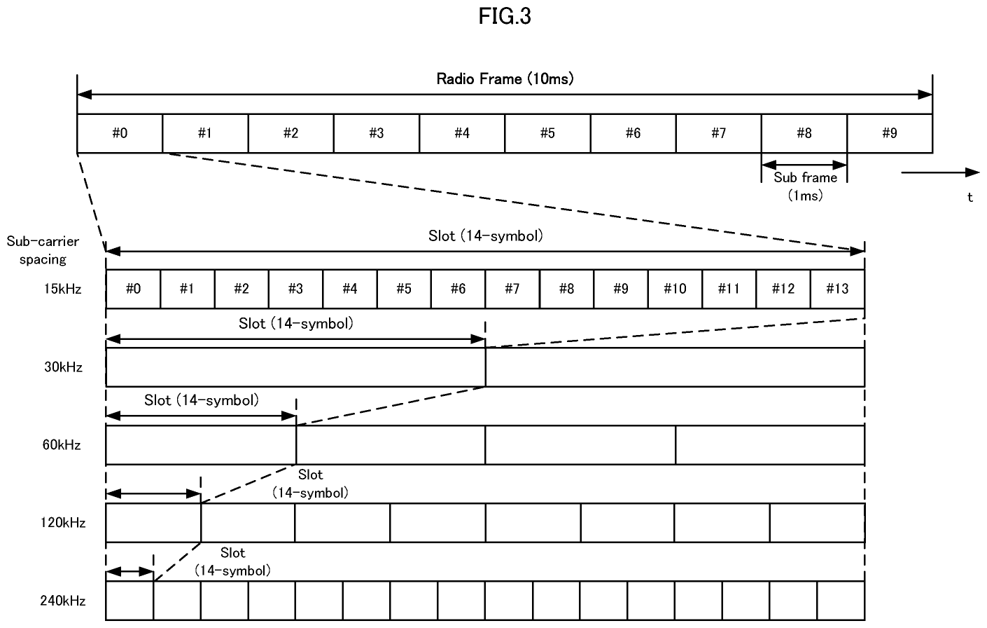

FIG. 3 shows an example configuration of the radio frame, subframe and slot used in radio communication system 10.

As shown in FIG. 3, one slot consists of 14 symbols, and the larger (wider) the SCS, the shorter the symbol period (and slot period). SCS is not limited to the intervals (frequencies) shown in FIG. 3. For example, 480 kHz, 960 kHz, etc., may be used.

In addition, the number of symbols constituting 1 slot need not necessarily be 14 symbols (For example, 28, 56 symbols). Furthermore, the number of slots per subframe may vary depending on the SCS.

Note that the time direction (t) shown in FIG. 3 may be referred to as a time domain, symbol period or symbol time. The frequency direction may also be referred to as a frequency domain, resource block, subcarrier or bandwidth part (BWP).

DMRS is a type of reference signal that is prepared for various channels. Here, unless otherwise noted, the term may refer to the downlink data channel, specifically, DMRS for the Physical Downlink Shared Channel (PDSCH). However, the upstream data channel, specifically, DMRS for the Physical Uplink Shared Channel (PUSCH), may be interpreted in the same way as DMRS for the PDSCH.

DMRS may be used for channel estimation in a device, e.g., a UE 200, as part of coherent demodulation. DMRS may only reside in a resource block (RB) used for PDSCH transmission.

DMRS may have multiple mapping types. Specifically, DMRS has mapping type A and mapping type B. In mapping type A, the first DMRS is placed on the second or third symbol of the slot. In mapping type A, the DMRS may be mapped relative to the slot boundary regardless of where the actual data transmission begins in the slot. The reason the first DMRS is placed on the second or third symbol of the slot may be interpreted as placing the first DMRS after the control resource sets (CORESET).

In mapping type B, the first DMRS may be placed on the first symbol of the data allocation. That is, the position of the DMRS may be given relative to where the data is placed, not relative to the slot boundary.

In addition, the DMRS may have multiple types (Types). Specifically, the DMRS has Type 1 and Type 2. Type 1 and Type 2 differ in the maximum number of mapping and orthogonal reference signals in the frequency domain. Type 1 can output up to four orthogonal signals with single-symbol DMRS, and Type 2 can output up to eight orthogonal signals with double-symbol DMRS.

(2) Function Block Configuration of Radio Communication System

Next, the functional block configuration of radio communication system 10 will be described. Specifically, the functional block configuration of the UE 200 will be described.

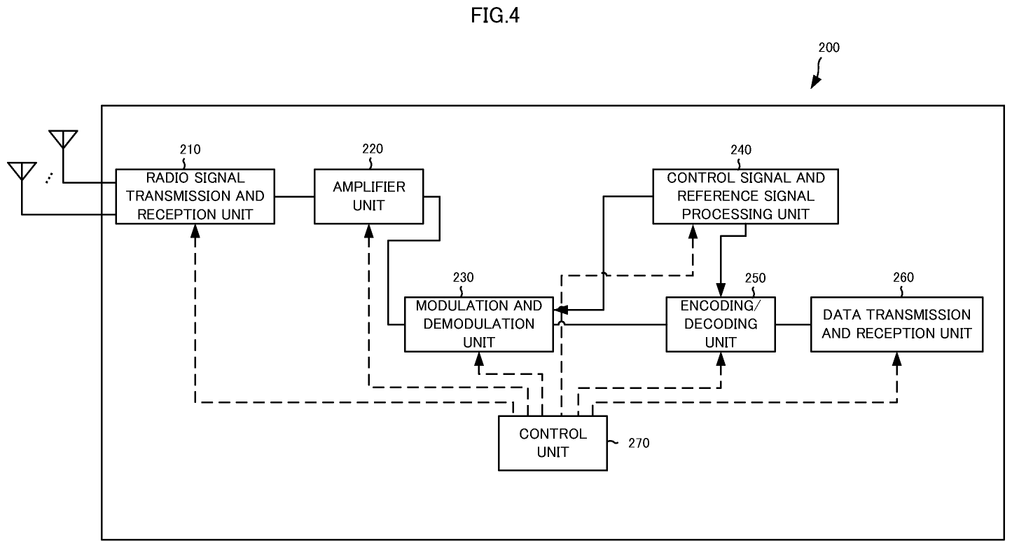

FIG. 4 is a functional block configuration diagram of the UE 200. As shown in FIG. 4, the UE 200 comprises a radio signal transmission and reception unit 210, an amplifier unit 220, a modulation and demodulation unit 230, a control signal and reference signal processing unit 240, an encoding/decoding unit 250, a data transmission and reception unit 260 and a control unit 270.

The radio signal transmission and reception unit 210 transmits and receives radio signals in accordance with NR. The radio signal transmission and reception unit 210 supports Massive MIMO, CA for bundling multiple CCs, and DC for simultaneously communicating between UE and each of the 2 NG-RAN nodes.

In an embodiment, the radio signal transmission and reception unit 210 constitutes a transmission unit that transmits the random access preamble as the first message (Msg1 below) in a random access procedure (Below is the RACH (Random Access Channel) procedure.). The radio signal transmission and reception unit 210 constitutes a reception unit that receives the second message (Msg2 below) as a response message to Msg 1 in a RACH procedure. After receiving Msg 2, the radio signal transmission and reception unit 210 transmits the third message (Msg3 below) via PUSCH in a RACH procedure. radio signal transmission and reception unit 210 receives the fourth message (Msg4 below) as a response message for Msg 3 in a RACH procedure (3GPP TS 38.321 V 16.2.1 § 5.1 “Random Access procedure”).

For example, Msg 1 may be transmitted via PRACH (Physical Random Access Channel). Msg 1 may be referred to as PRACH Preamble. Msg 2 may be transmitted via PDSCH. Msg 2 may be referred to as RAR (Random Access Response). Msg 3 may be referred to as RRC Connection Request. Msg4 may be referred to as RRC Connection Setup.

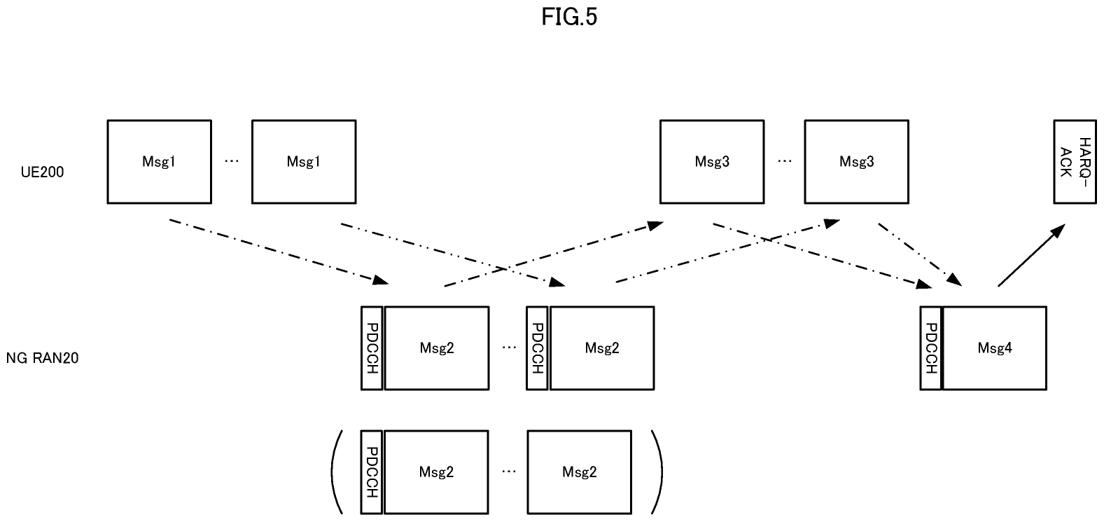

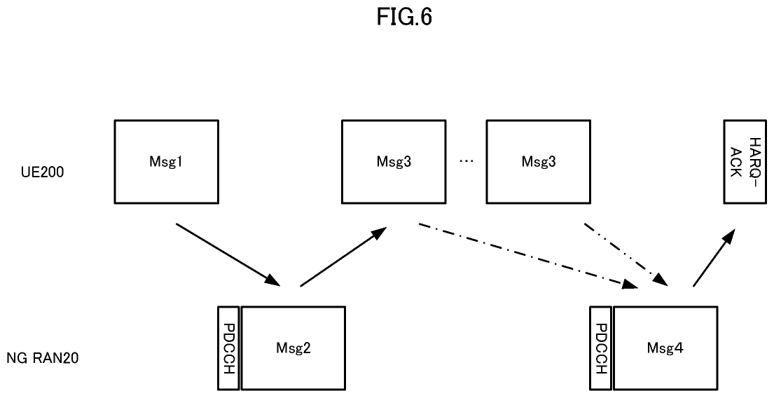

Under such a background, the radio signal transmission and reception unit 210 performs repetitive transmission of Msg3. Details of repetitive transmission of Msg3 will be described later (see FIGS. 5 and 6).

The amplifier unit 220 is composed of PA (Power Amplifier)/LNA (Low Noise Amplifier), etc. The amplifier unit 220 amplifies the signal output from the modulation and demodulation unit 230 to a prescribed power level. The amplifier unit 220 amplifies the RF signal output from radio signal transmission and reception unit 210.

The modulation and demodulation unit 230 performs data modulation/demodulation, transmission power setting and resource block allocation for each predetermined communication destination (gNB 100 or other gNB). For the modulation and demodulation unit 230, Cyclic Prefix-Orthologous Frequency Division Multiplexing (CP-OFDM)/Discrete Fourier Transform-Spread (DFT-S-OFDM) may be applied. DFT-S-OFDM may be used not only for the uplink (UL) but also for the downlink (DL).

The control signal and reference signal processing unit 240 performs processing for various control signals transmitted and received by the UE 200 and processing for various reference signals transmitted and received by the UE 200.

Specifically, the control signal and reference signal processing unit 240 receives various control signals transmitted from the gNB 100 via a predetermined control channel, such as control signals of a radio resource control layer (RRC). The control signal and reference signal processing unit 240 also transmits various control signals toward the gNB 100 via a predetermined control channel.

The control signal and reference signal processing unit 240 performs processing using a reference signal (RS) such as a Demodulation Reference Signal (DMRS) and a Phase Tracking Reference Signal (PTRS).

DMRS is a known reference signal (pilot signal) between individual base stations and terminals for estimating the fading channel used for data demodulation. PTRS is a reference signal for individual terminals for estimating phase noise, which is a problem in high frequency bands.

In addition to DMRS and PTRS, the reference signal may include Channel State Information-Reference Signal (CSI-RS), Sounding Reference Signal (SRS), and Positioning Reference Signal (PRS) for location information.

In addition, the channel includes a control channel and a data channel. The control channels include PDCCH (Physical Downlink Control Channel), PUCCH (Physical Uplink Control Channel), RACH (Random Access Channel), Downlink Control Information (DCI) including Random Access Radio Network Temporary Identifier (RA-RNTI), and Physical Broadcast Channel (PBCH).

The data channels include PDSCH (Physical Downlink Shared Channel) and PUSCH (Physical Uplink Shared Channel). Data means data transmitted through a data channel. Data channels may be read as shared channels.

Here, the control signal and reference signal processing unit 240 constitutes a reception unit that receives downlink control information (DCI). The DCI includes fields that store, as existing fields, DCI Formats, Carrier indicator (CI), BWP indicator, Frequency Domain Resource Allocation (FDRA), Time Domain Resource Allocation (TDRA), Modulation and Coding Scheme (MCS), HARQ Process Number (HPN), New Data Indicator (NDI), Redundancy Version (RV), etc.

The values stored in the DCI Format fields are information elements that specify the format of the DCI. The values stored in the CI fields are information elements that specify the CC to which the DCI applies. The values stored in the BWP indicator fields are information elements that specify the BWP to which the DCI applies. The BWP that can be specified by the BWP indicator is set by an information element (BandwidthPart-Config) contained in the RRC message. The value stored in the FDRA field is an information element that specifies the frequency domain resource to which the DCI applies. Frequency domain resources are identified by the value stored in the FDRA field and the information element (RA Type) contained in the RRC message. The value stored in the TDRA field is the information element that specifies the time domain resource to which the DCI applies. The time domain resource is identified by the value stored in the TDRA field and the information element (pdsch-TimeDomainAllocationList, pusch-TimeDomainAllocationList) contained in the RRC message. The time domain resource may be identified by the value stored in the TDRA field and the default table. The value stored in the MCS field is the information element that specifies the MCS to which the DCI applies. The MCS is identified by the value stored in the MCS and the MCS table. The MCS table may be specified by an RRC message or identified by RNTI scrambling. The value stored in the HPN field is an information element that specifies the HARQ Process to which the DCI applies. The value stored in the NDI is an information element that specifies whether the data to which the DCI applies is first-time data. The value stored in the RV field is an information element that specifies the redundancy of the data to which the DCI applies.

In an embodiment, the DCI includes the time domain resource allocation (TDRA) of the uplink channel (PUSCH). The DCI including the TDRA of PUSCH may be a DCI of Format 0_0, Format 0_1 or Format 0_2.

The encoding/decoding unit 250 performs data division/concatenation and channel coding/decoding for each predetermined communication destination (gNB 100 or other gNB).

Specifically, the encoding/decoding unit 250 divides the data output from the data transmission and reception unit 260 into predetermined sizes and performs channel coding on the divided data. The encoding/decoding unit 250 also decodes the data output from the modulation and demodulation unit 230 and concatenates the decoded data.

The data transmission and reception unit 260 transmits and receives protocol data units (PDU) and service data units (SDU). Specifically, data transmission and reception unit 260 performs such tasks as assembling/disassembling PDUs/SDUs in multiple layers (Media access control layer (MAC), radio link control layer (RLC), and packet data convergence protocol layer (PDCP), etc.). data transmission and reception unit 260 also performs data error correction and retransmission control based on a hybrid automatic repeat request (ARQ).

The control unit 270 controls each functional block that constitutes the UE 200. For example, in an embodiment, the control unit 270 controls the RACH procedure described above.

(3) Repetitive Transmission of the Third Message

The repetitive transmission of the third message (Msg3) is described below. The repetitive transmission of Msg3 may include the first repetitive transmission and the second repetitive transmission described below.

(3.1) First Repeat Transmission

As shown in FIG. 5, in the first repeat transmission, the UE 200 executes the repeat transmission of Msg 1. The repeat transmission of Msg 1 is executed regardless of whether Msg 2 is received from NG RAN 20 (For example, gNB 100). Therefore, the repeat transmission of Msg 1 is a different concept from the retransmission of Msg 1 with a power ramping. UE 200 receives Msg 2 corresponding to each Msg 1 from NG RAN 20. UE 200 transmits Msg 3 corresponding to each Msg 2 to NG RAN 20. UE 200 receives Msg 4 for any one of Msg 3 from NG RAN 20. UE 200 transmits an acknowledgement (HARQ-ACK) for Msg 4 to NG RAN 20.

Thus, in the first repeat transmission, UE 200 executes the repeat reception of Msg 2 corresponding to each Msg 1 by executing the repeat transmission of Msg 1. The UE 200 performs repetitive transmission of Msg 3 by transmitting Msg 3 corresponding to each Msg 2.

In the first repetitive transmission, the UE 200 may calculate RA-RNTI based on RACH occurrence. The UE 200 may decode the PDCCH corresponding to each Msg2 using a different RA-RNTI for each Msg2. The NG RAN 20 may set a different TC-RNTI (Temporary Cell Radio Network Temporary Identifier) for each Msg1. The UE 200 may transmit Msg3 corresponding to each Msg2 using a different RA-RNTI for each Msg2. On the other hand, the UE 200 may transmit Msg3 corresponding to each Msg2 using the same UE id. The NG RAN 20 may identify two or more Msg3 to be received from the same UE 200 based on the UE id contained in each Msg3, and transmit Msg4 using the C-RNTI with the TC-RNTI selected from the TC-RNTI of the identified two or more Msg3 as one C-RNTI (Cell Radio Network Temporary Identifier). The NG RAN 20 may select the Msg3 with the best reception quality from the two or more Msg3 to be received from the same UE 200 and transmit the Msg4 for the selected Msg3.

According to the first iteration transmission, the channel quality of the PUSCH used for transmitting Msg3 can be improved because the repetitive transmission of Msg3 increases the possibility of Msg3 reaching NG RAN 20, even when the effects such as fading are considered.

FIG. 5 illustrates a case where the resources of Msg2 and Msg3 are allocated by the number of PDCCHs corresponding to the number of repetitive transmissions of Msg1. However, the first repetitive transmission is not limited to this. Resources for repetitive reception of Msg2 and repetitive transmission of Msg3 may be allocated by at least one of one PDCCH and one RAR PDSCH. In such a case, NG RAN 20 may allocate resources for repetitive transmission of Msg2 and Msg3 by one PDCCH for one Msg1 selected from each Msg1. NG RAN 20 may allocate resources for repetitive transmission of Msg2 and Msg3 by one PDCCH for two or more Msg1 selected from each Msg1. With such a configuration, since the resources for repetitive transmission of Msg3 are known in NG RAN 20, the channel quality of PUSCH can be improved by synthetic reception of Msg3.

(3.2) Second Repetitive Transmission

As shown in FIG. 6, in the second repeat transmission, the UE 200 transmits Msg1 to NG RAN 20 (For example, gNB 100) without executing the repeat transmission of Msg1. In the transmission of Msg1, the retransmission of Msg1 with a power ramping may be executed. The UE 200 receives Msg2 corresponding to Msg1 from the NG RAN 20. The UE 200 transmits Msg3 corresponding to Msg2 to the NG RAN 20. The UE 200 receives Msg4 for any one of the Msg3 from the NG RAN 20. The UE 200 transmits an acknowledgement (HARQ-ACK) for Msg4 to the NG RAN 20.

Thus, in the second repeat transmission, the UE 200 executes the repeat transmission of Msg3 without executing the repeat transmission of Msg1. That is, the second repeat transmission differs from the first repeat transmission in that the repeat transmission of Msg1 and the repeat reception of Msg2 are not executed.

For the second repeat transmission, NG RAN 20 may allocate resources for the repeat transmission of Msg 3 by one PDCCH. That is, the resources for the repeat transmission of Msg 3 are known in NG RAN 20. Therefore, NG RAN 20 is able to identify 2 or more Msg 3 that are received from the same UE 200 before decoding Msg 3 (In other words, without using UEid). With such a configuration, NG RAN 20 is able to perform synthetic reception of Msg 3.

According to the second iteration transmission, the channel quality of PUSCH can be improved by synthetic reception of Msg 3 even when effects such as fading are considered.

(4) Method of Repetitive Transmission

The method of repetitive transmission of the third message (Msg3) is described below. The following methods are considered as the method of repetitive transmission of Msg3.

As mentioned above, Msg3 is transmitted via PUSCH. Therefore, the existing PUSCH mapping type can be utilized as a resource for repetitive transmission of Msg3.

The PUSCH mapping type defines the starting position of symbols that can be assigned to PUSCH (S) and the number of symbols that can be assigned to PUSCH (L). The PUSCH mapping type may be defined by S+L. The values of S, L and S+L may be defined for each CP (Cyclic Prefix) length. The values of S, L and S+L may be defined for each PUSCH repetition Type.

Existing PUSCH mapping types include Type A and Type B. Type A is used only for Repetition Type A, and Type B is used for both Repetition Type A and Repetition Type A. Existing Type A and Type B assume per-slot allocation so that the value of L does not exceed “14” (see section 6.1.2 of 3GPP TS 38.214 V 16.2.0).

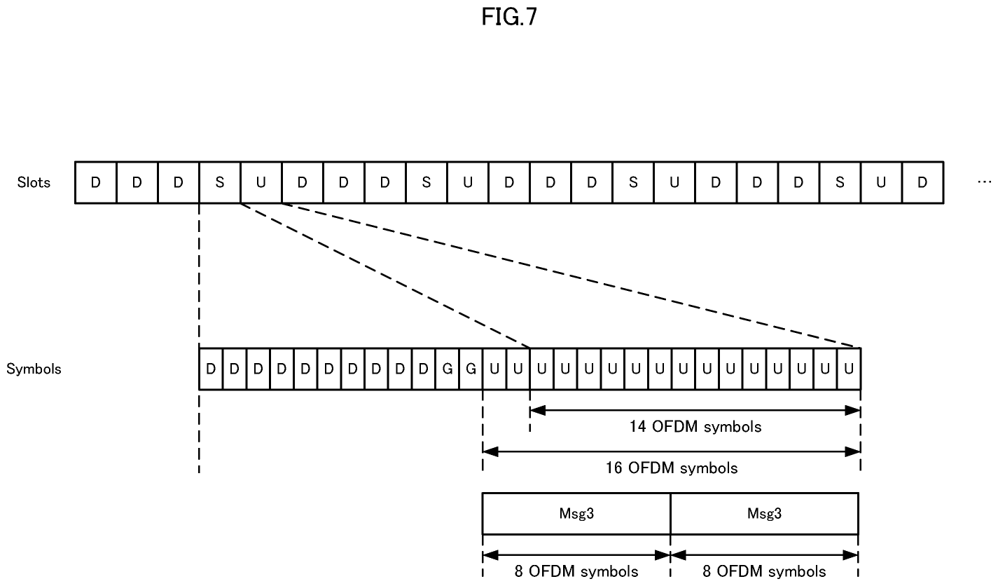

Against this background, we will explain the case where the TDD pattern is “DDDSU” as shown in FIG. 7. “D” means the slot used only for the symbol of the downlink (Below, D-slot), “U” means the slot used only for the symbol of the uplink (U-slot below), and “S” means the slot used for the symbol of the downlink and the uplink (Below, S slot).

We also describe a case where 1 slot contains 14 symbols. “D” stands for the symbol used for the downlink (Below, D symbol), “U” stands for the symbol used for the uplink (U symbol below), and “G” stands for the guard symbol (Below: G symbol).

First, when Type A is used as a resource for repetitive transmission of Msg 3, NG RAN 20 may specify the interval of slots used for repetitive transmission of Msg 3. For example, when the TDD pattern is “DDDSU,” the D and S slots are dropped, so “0” may be specified as the slot interval used for repetitive transmission of Msg3. Note that in Type A, the values of S, L and S+L are common for each slot.

Second, when Type B is used as a resource for repetitive transmission of Msg 3, NG RAN 20 may specify the U symbol (2) at the end of the S slot and the U symbol (s) of the U slot as one resource unit. In other words, NG RAN 20 may specify the values S, L and S+L as specifying 16 consecutive U symbols. In such cases, the possible range of L may include values (For example, “16”) greater than the number of symbols (Here, “14”) contained in a single slot. With such a configuration, assuming a case in which the number of symbols in Msg3 is 8, it is possible to perform two repeated Msg3 transmissions using 16 consecutive U symbols.

(5) Whether Repetitive Transmissions can be Performed

Whether or not to perform repetitive transmissions of Msg3 may be notified by the following method.

First, the UE 200 may receive notification information from the NG RAN 20 including an information element indicating whether to perform repetitive transmission of Msg 3. Such information element may include an information element indicating the number of repetitive transmissions. The notification information may be a System Information Block (SIB). The information element may be a RACH-ConfigCommon included in SIB1. A RACH-ConfigCommon may be included in a BWP-UplinkCommon (TS 38.331 V 16.2.0 § 6.3.2 “Radio resource control Information element”).

Here, the information element indicating whether or not to perform repetitive transmission of Msg3 may be an example of the information element related to repetitive transmission. That is, the UE 200 may receive notification information including the information element related to repetitive transmission. With such a configuration, repetitive transmission of Msg 3 can be realized without the expansion of the message (For example, Msg2) related to the RACH procedure.

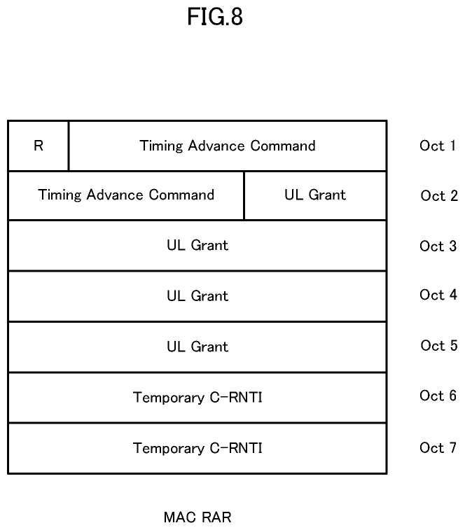

Second, Msg 2 may be received from NG RAN 20 with an information element indicating whether to perform repetitive transmission of Msg 3. Such an information element may include an information element indicating the number of repetitive transmissions. As shown in FIG. 8, Msg2 (RAR) contains a UL Grant, and the information element may be a ULGrant. In such a case, NG RAN 20 may determine the number of repetitive transmissions based on the received power of Msg1, similar to the TPC (Transmission Power control) command included in the RAR.

Here, the information element indicating whether to execute the repetitive transmission of Msg3 may be an example of the information element related to the repetitive transmission. That is, the UE 200 may receive Msg2 containing the information element related to the repetitive transmission. With such a configuration, the number of repetitive transmissions of Msg3 can be flexibly set for each UE 200.

(6) Resource of Repetitive Transmission

The resource of repetitive transmission of Msg3 may be notified in the following manner:

First, the UE 200 may receive notification information from the NG RAN 20 that includes an information element indicating the repetition Type. The UE 200 may receive Msg 2 from the NG RAN 20 that includes an information element indicating the repetition Type. If the repetition Type is Type A, the information element may include an information element indicating the interval of slots used for repetitive transmission of Msg 3. If the repetition Type is Type B, the information element may include an information element indicating the values of S, L, S+L used for repetitive transmission of Msg 3.

Here, the information element indicating the repetition Type may be an example of an information element related to repetitive transmission. That is, the UE 200 may receive notification information including an information element related to repetitive transmission. The UE 200 may receive an Msg 2 containing information elements about repetitive transmissions.

Second, the RV (Redundancy Version) used in repetitive transmissions of Msg 3 may be predetermined. The UE 200 may receive notification information from the NG RAN 20 including information elements indicating the RV used in repetitive transmissions of Msg 3. The UE 200 may receive Msg 2 including information elements indicating the RV used in repetitive transmissions of Msg 3 from the NG RAN 20. For example, the RV may be defined according to the number of repetitive transmissions.

Here, the information element indicating the RV used in the repetitive transmission of Msg3 may be an example of the information element related to the repetitive transmission. That is, the UE 200 may receive notification information including the information element related to the repetitive transmission. The UE 200 may receive Msg 2 including the information element related to the repetitive transmission.

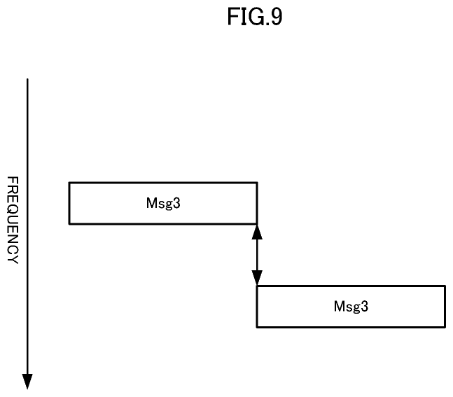

Third, as shown in FIG. 9, frequency hopping may be applied in the repetitive transmission of Msg3. In FIG. 9, a case is illustrated in which two repetitive transmissions are performed on 16 consecutive U symbols. The UE 200 may receive broadcast information from the NG RAN 20 including information elements indicating a frequency hopping pattern. The UE 200 may receive Msg 2 including information elements indicating a frequency hopping pattern from the NG RAN 20.

For example, if the repetition Type is Type A, inter-slot hopping may be applied. With inter-slot hopping, frequency hopping with a specified offset is performed for each repetitive transmission (slot). If the repetition Type is Type A, intra-slot hopping may be applied. For intra-slot hopping, the same frequency hopping pattern is used for each repetitive transmission (slot).

Similarly, inter-slot hopping may be applied if the repetition Type is Type B. Inter-slot hopping performs frequency hopping at a specified offset for each repetitive transmission (slot). If the repetition Type is Type B, intra-slot hopping may be applied. For intra-slot hopping, the same frequency hopping pattern is used for each repetitive transmission (slot).

Here, the information element indicating the frequency hopping pattern may include an information element specifying the repetition type of the repetitive transmission. Such an information element may be referred to as a pusch-RepTypeIndicator, and the information element indicating the frequency hopping pattern may include an information element specifying the frequency hopping within or between slots. Such an information element may be specified for each repetition type and may be referred to as frequencyHoppingMsg3-RepTypeA and frequencyHoppingMsg3-RepTypeB. The push-RepTypeIndicator, frequencyHoppingMsg3-RepTypeA and frequencyHoppingMsg3-RepTypeB may be included in the RACH-Config Common.

The information element indicating the frequency hopping pattern may include an information element indicating the specified offset used in frequency hopping. Such information elements may be referred to as frequencyHoppingOffset. The frequencyHoppingOffset may be included in the RACH-Config Common. The frequencyHoppingOffset may be included in Msg2. The specified offset may be defined in advance by the bandwidth used in the transmission of Msg3.

Here, the information element indicating the frequency hopping pattern may be an example of the information element related to the repetitive transmission. That is, the UE 200 may receive the broadcast information including the information element related to the repetitive transmission. The UE 200 may receive the Msg 2 including the information element related to the repetitive transmission.

(7) Operational Effects

In the embodiment, the UE 200 performs repetitive transmission of Msg3 when transmitting Msg3 via PUSCH in the RACH procedure. With such a configuration, the channel quality of the PUSCH used for transmitting Msg3 can be improved.

### Modification Example 1

Modification Example 1 of the embodiment will be described below. The differences from the embodiment will be mainly described below.

In Modification Example 1, the beam pattern of gNB 100 will be described. Specifically, the relationship between the beam used for receiving Msg1 and transmitting Msg2 and the beam used for receiving Msg3 is described. The beam used for receiving Msg1 and transmitting Msg2 may be the beam used for transmitting the Synchronization Signal Block (SSB) (below, SSB Beam). The beam used for receiving Msg3 may be the beam used for transmitting the CSI-RS (below, CSI-RS Beam). Here, the second repeat transmission described above (FIG. 6) is used as an example.

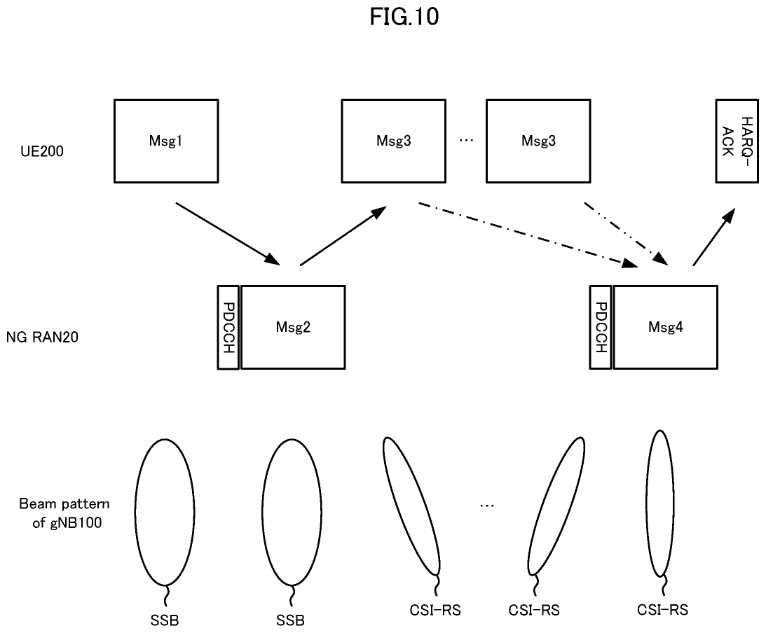

As shown in FIG. 10, assuming that the CSI-RS Beam is narrower than the SSB Beam, the beam pattern of the gNB 100 is switched as shown below.

The gNB 100 receives Msg 1 using the SSB Beam. The gNB 100 transmits Msg 2 using the SSB Beam. On the other hand, the gNB 100 receives Msg 3 using the CSI-RS Beam. In such a case, the gNB 100 switches the orientation of the CSI-RS Beam for each repetitive transmission of Msg 3. The orientation of the CSI-RS Beam may be the same as that of the SSB Beam used in receiving Msg 1 or transmitting Msg 2. In other words, the gNB 100 may switch the orientation of the CSI-RS Beam for each repetitive transmission of Msg 3 within the range of the SSB Beam used in receiving Msg 1 or transmitting Msg 2. The gNB 100 transmits Msg 4 using the CSI-RS Beam used in receiving Msg 3 selected from each Msg 3. The Msg 3 selected from each Msg 3 may be the Msg 3 with the best reception quality.

With such a configuration, the gNB 100 Attempts to receive Msg 3 with a narrower (more directional) CSI-RS Beam than the SSB Beam because it switches the direction of the CSI-RS Beam for each repetitive transmission of Msg 3. Therefore, the possibility of receiving Msg 3 with good reception quality is increased, and the channel quality of the PUSCH used for transmitting Msg 3 is improved.

Under such a background, the following beams can be considered as the beams used by the UE 200 when transmitting Msg 3.

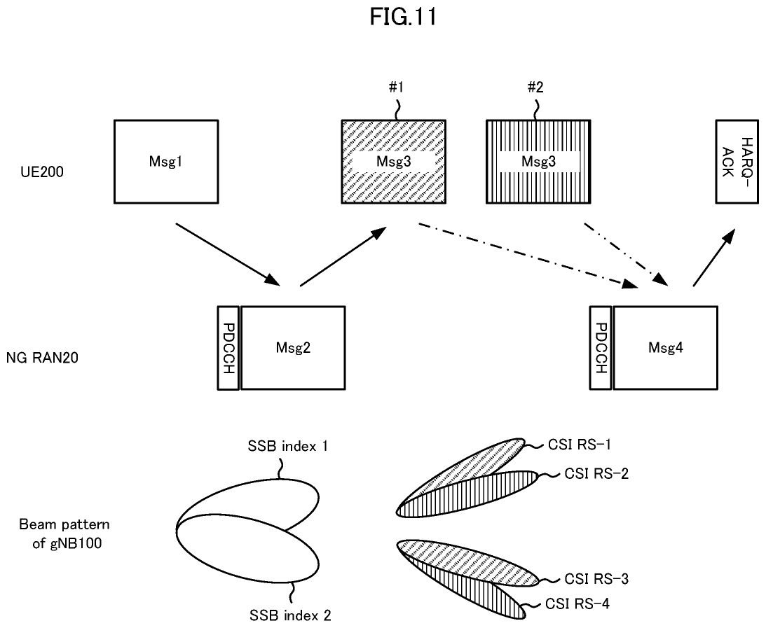

First, the UE 200 may transmit Msg 3 using a beam similar to Msg 1. For example, as shown in FIG. 11, an example is given where the index of each CSI-RS (CSI-RS-1 to CSI-RS-4) is associated with the index of the SSB (SSB index 1, SSB index 2). Specifically, CSI-RS-1 and CSI-RS-2 are associated with SSB index 1, and the orientation of the CSI-RS beams of CSI-RS-1 and CSI-RS-2 is the same as that of the SSB beam of SSB index 1. Similarly, CSI-RS-3 and CSI-RS-4 are associated with SSB index 2, and the orientation of the CSI-RS beams of CSI-RS-3 and CSI-RS-4 is the same as that of the SSB beam of SSB index 2.

In such a case, the gNB 100 receives Msg1 and transmits Msg2 using the SSB beams corresponding to SSB index 1 and SSB index 2. On the other hand, the gNB 100 receives Msg #1 using the CSI-RS beams corresponding to CSI-RS-1 and CSI-RS 3 and receives Msg #2 using the CSI-RS beams corresponding to CSI-RS-2 and CSI-RS 4. The UE 200 transmits Msg 3 using the same beams as Msg 1.

With such a configuration, the channel quality of the PUSCH used for Msg 3 transmission can be improved without changing the specifications of the UE 200.

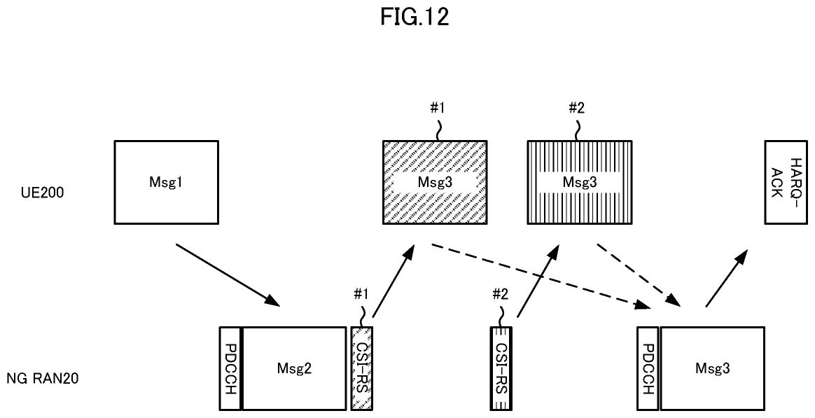

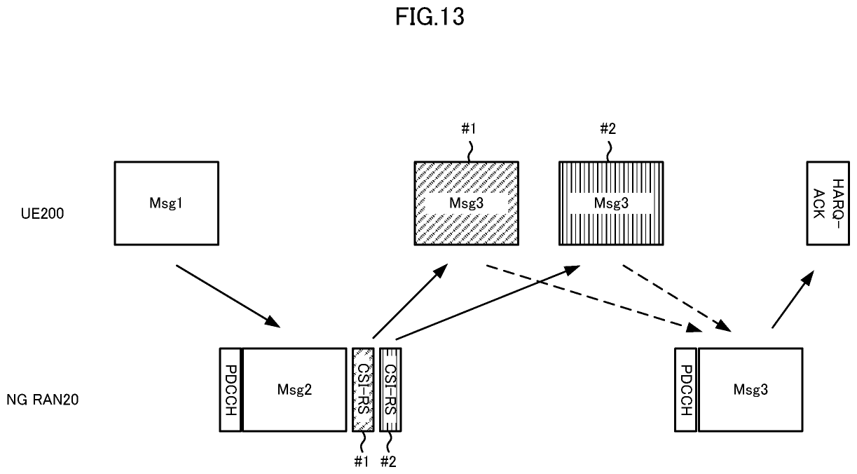

Second, the UE 200 may select a beam to transmit Msg 3 based on the CSI-RS received from the gNB 100 And transmit Msg 3 using the selected beam. For example, as shown in FIG. 12 and FIG. 13, the gNB 100 transmits 2 or more CSI-RS after transmitting Msg 2. The orientation of the CSI-RS beams used for transmitting 2 or more CSI-RS may be different. When receiving CSI-RS #1, the UE 200 transmits Msg 3 #1 using a beam (CSI-RS Beam) adjusted to the orientation of CSI-RS #1. Similarly, when receiving CSI-RS #2, the UE 200 transmits Msg 3 #2 using a beam (CSI-RS Beam) adjusted to the orientation of CSI-RS #2.

FIG. 12 illustrates a case in which the resource of CSI-RS #2 is allocated later in time than the resource of Msg 3 #1 corresponding to CSI-RS #1. That is, in FIG. 12, the resource of CSI-RS and the resource of Msg 3 are allocated alternately.

On the other hand, FIG. 13 illustrates a case in which resources of CSI-RS #2 are allocated ahead of the resources of Msg3 #1 corresponding to CSI-RS #1 in time. That is, in FIG. 13, resources of CSI-RS are allocated sequentially and then resources of Msg3 are allocated sequentially.

As explained using FIGS. 12 and 13, after receiving the second message (Msg2), the UE 200 receives two or more channel state information reference signals (CSI-RS). The UE 200 transmits the third message (Msg3) based on the CSI-RS selected from the two or more CSI-RS. The UE 200 may transmit Msg3 using a beam (CSI-RS Beam) adjusted to the orientation of the selected CSI-RS.

Here, in the case shown in FIG. 12, since the resources of CSI-RS and those of Msg3 are allocated alternately, it is not possible to compare 2 or more CSI-RS before transmitting Msg3. Therefore, the CSI-RS selected from 2 or more CSI-RS may be considered to be all CSI-RS. In other words, the UE 200 transmits the same number of Msg 3 as the number of CSI-RS. With this configuration, the UE 200 can use the measurement results of CSI-RS acquired by the RACH procedure as a CSI Report after establishing the RRC connection. Since Msg 3 is transmitted for each CSI-RS in the case shown in FIG. 12, this aspect may be considered to include repetitive transmission of Msg 3.

On the other hand, in the case shown in FIG. 13, since the resources of Msg 3 are continuously allocated after the resources of CSI-RS are continuously allocated, two or more CSI-RS can be compared before the transmission of Msg 3. Therefore, the CSI-RS selected from two or more CSI-RS may be the CSI-RS with the best reception quality. In other words, the UE 200 may transmit one Msg 3 corresponding to the CSI-RS with the best reception quality. With such a configuration, the UE 200 can use the measurement results of the CSI-RS obtained by the RACH procedure as a CSI Report after establishing the RRC connection. Furthermore, the number of Msg 3 transmissions by the UE 200 can be reduced. In addition, even in the case where the same Msg 1 resource is shared among the UE 200 when Msg 1 is transmitted, a collision can be avoided if each UE 200 transmits Msg 3 with a different resource. Since Msg3 need not be transmitted for each CSI-RS in the case shown in FIG. 13, such an aspect may not include repetitive transmission of Msg3.

Here, the resources of the CSI-RS transmitted in the RACH procedure may be notified to the UE 200 by means of notification information (For example, RACH-ConfigCommon) or may be notified to the UE 200 by means of Msg2.

### Modification Example 2

Modification Example 2 of the embodiment will be described below. Differences from the embodiment will be mainly described below.

In the embodiment, repetitive transmission of Msg3 is mainly described. On the other hand, in the modification example 2, a case in which the UE 200 does not perform repetitive transmission of Msg3 but the UE 200 performs repetitive reception of Msg2 is described.

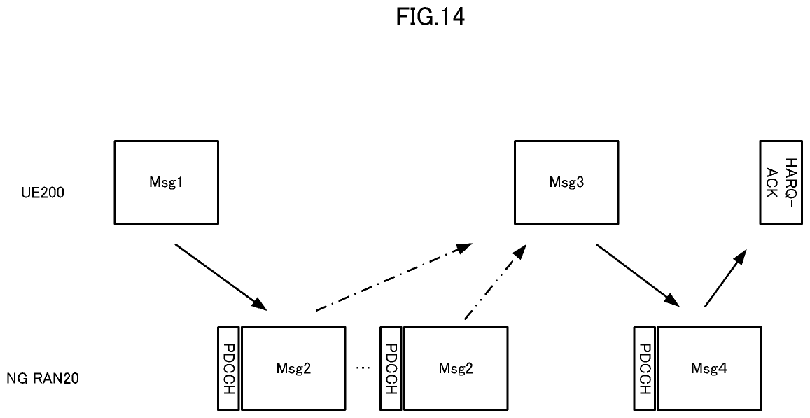

As shown in FIG. 14, the UE 200 transmits Msg 1 to NG RAN 20. The repetitive transmission of Msg 1 need not be performed. NG RAN 20 performs the repetitive transmission of Msg 2. In other words, UE 200 performs the repetitive reception of Msg 2. UE 200 may select Msg 2 with the best reception quality from two or more Msg 2 received from NG RAN 20 and transmit Msg 3 for the selected Msg 2. NG RAN 20 transmits Msg 4 for Msg 3.

Thus, UE 200 performs repetitive reception of the second message (Msg 2) and transmits the third message (Msg 3) based on the Msg 2 selected from the Msg 2 received in the repetitive reception. The Msg 2 selected from the Msg 2 may be the Msg 2 with the best reception quality.

Here, the resources of Msg 2 to which repetitive transmission is applied in the RACH procedure may be notified to the UE 200 by means of announcement information (For example, RACH-ConfigCommon).

### Other Embodiments

Although the contents of the present invention have been described above in accordance with the embodiment, the present invention is not limited to these descriptions, and it is obvious to those skilled in the art that various modifications and improvements are possible.

Although not specifically mentioned in the above disclosure, information regarding the repetitive transmission of Msg3 may be included in both the announcement information (For example, RACH-ConfigCommon) and Msg2. In such a case, the candidate parameters to be used in the repetitive transmission of Msg3 may be specified by the information elements included in the announcement information, and the parameters actually used in the repetitive transmission of Msg3 may be specified by the information elements included in Msg2. The information elements included in Msg2 may be indexes associated with the parameters. For example, the information elements included in the broadcast information may specify candidates for the number of repetitive transmissions of Msg3, and the information elements included in Msg2 may specify the number of times actually used in repetitive transmissions of Msg3. Similarly, the information element contained in the broadcast information may specify the candidate of frequency hopping (For example, the specified offset) to be used in the repetitive transmission of Msg3, and the information element contained in Msg2 may specify the frequency hopping (For example, the specified offset) actually used in the repetitive transmission of Msg3.

Although not specifically mentioned in the above disclosure, the CSI-RS resources transmitted in the RACH procedure may be contained in both the broadcast information (For example, RACH-ConfigCommon) and Msg2. In such a case, the information elements contained in the broadcast information may specify the candidate CSI-RS resources, and the information elements contained in Msg2 may specify the CSI-RS resources.

The block diagram (FIG. 4) used for the description of the above described embodiment shows the functional unit blocks. Those functional blocks (structural components) can be realized by a desired combination of at least one of hardware and software. Means for realizing each functional block is not particularly limited. That is, each functional block may be realized using one physically or logically coupled device, or two or more physically or logically separated devices may be directly or indirectly connected (For example, using wired, wireless, etc.) and realized using these multiple devices. The functional block may be realized by combining the software with the one device or the multiple devices.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that makes transmission work is called a transmission unit (transmitting unit) or transmitter. In either case, as described above, the implementation method is not particularly limited.

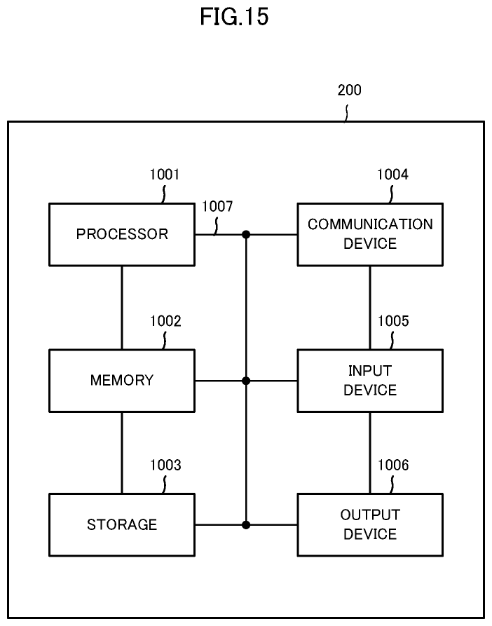

Furthermore, the UE 200 (the device) described above may function as a computer that performs processing of the radio communication method of this disclosure. FIG. 15 shows an example of the hardware configuration of the device. As shown in FIG. 15, the device may be configured as a computer device including a processor 1001, a memory 1002, a storage 1003, an communication device 1004, an input device 1005, an output device 1006, a bus 1007, etc.

Furthermore, in the following explanation, the term “device” can be replaced with a circuit, device, unit, and the like. The hardware configuration of the device may be configured to include one or more of each device shown in the figure, or it may be configured without some of the devices.

Each functional block of the device (see FIG. 4) is realized by any hardware element of the computer device, or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001 controls the entire computer by, for example, operating the operating system. The processor 1001 may consist of a central processing unit (CPU) including interfaces with peripheral devices, controllers, arithmetic units, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Furthermore, the various processes described above may be executed by one processor 1001 or simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, a cache, a main memory (main memory), etc. The memory 1002 may store a program (program code), a software module, etc., capable of executing a method according to one embodiment of this disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device such as a processor 1001 and a memory 1002 is connected by a bus 1007 for communicating information. The bus 1007 may be configured using a single bus or different buses for each device.

Furthermore, the device may be configured including hardware such as a microprocessor, a digital signal processor (DSP), an application specific integrated circuit (ASIC), a programmable logic device (PLD), a field programmable gate array (FPGA), etc., with which some or all of the functional blocks may be implemented. For example, the processor 1001 may be implemented by using at least one of these hardware.

Also, the notification of information is not limited to the mode/embodiment described in this disclosure and may be made using other methods. For example, the notification of information may be carried out by physical layer signaling (e.g., Downlink Control Information (DCI), Uplink Control Information (UCI), higher layer signaling (e.g., RRC signaling, Medium Access Control (MAC) signaling, notification information (Master Information Block (MIB), System Information Block (SIB)), other signals or a combination thereof. The RRC signaling may also be referred to as an RRC message, e.g., an RRC Connection Setup message, an RRC Connection Reconfiguration message, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc., of each mode/embodiment described in this disclosure may be reordered as long as there is no conflict. For example, the method described in this disclosure uses an illustrative order to present elements of various steps and is not limited to the specific order presented.

The specific operation that is performed by the base station in the present disclosure may be performed by its upper node in some cases. In a network consisting of one or more network nodes with base stations, it is clear that various operations performed for communication with terminals can be performed by the base station and at least one of the other network nodes (For example, but not limited to MME or S-GW) other than the base station. In the above, an example in which there is one network node other than the base station is explained; however, a combination of a plurality of other network nodes (for example, MME and S-GW) may be used.

Information, signals (information, etc.) can be output from an upper layer (or lower layer) to a lower layer (or upper layer). It may be input and output via a plurality of network nodes.

The input/output information can be stored in a specific location (for example, a memory) or can be managed in a management table. Information that is input or output can be overwritten, updated, or appended. The information can be deleted after outputting. The inputted information can be transmitted to another device.

Decisions can be made by a value represented by a single bit (0 or 1), by a truth value (Boolean: true or false), or by comparing numbers (For example, a comparison with a given value).

Each aspect/embodiment described in this disclosure may be used alone, in combination, or switched over as practice progresses. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, if software is transmitted from a website, server, or other remote source using at least one of wireline technology (Coaxial cable, fiber optic cable, twisted pair, Digital subscriber Line (DSL), etc.) and wireless technology (Infrared, microwave, etc.), at least one of these wireline and wireless technologies is included within the definition of a transmission medium.

Information, signals, or the like mentioned above may be represented by using any of a variety of different technologies. For example, data, instructions, commands, information, signals, bits, symbols, chips, etc. that may be referred to throughout the above description may be represented by voltage, current, electromagnetic wave, magnetic field or magnetic particle, light field or photon, or any combination thereof.

It should be noted that the terms described in this disclosure and those terms necessary for the understanding of this disclosure may be replaced with terms having the same or similar meanings. For example, at least one of the channels and symbols may be a signal (signaling). Also, the signal may be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

A base station can house one or more (For example, three) cells, also called sectors. In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a base station performing communication services in this coverage and to part or all of the coverage area of at least one of the base station subsystems.

In the present disclosure, the terms “mobile station (Mobile Station: MS),” “user terminal,” “user equipment (User Equipment: UE),” “terminal” and the like can be used interchangeably.

A mobile station may be referred to by those skilled in the art as a subscriber station, mobile unit, subscriber unit, wireless unit, remote unit, mobile device, radio communication device, remote device, mobile subscriber station, access terminal, mobile terminal, wireless terminal, remote terminal, handset, user agent, mobile client, client, or some other appropriate term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, airplanes, etc.), an unattended mobile (For example, drones, self-driving cars, etc.), or a robot (manned or unmanned). At least one of a base station and a mobile station can be a device that does not necessarily move during the communication operation. For example, at least one of a base station and a mobile station may be an Internet of Things (IoT) device such as a sensor.

The base station in this disclosure may also be read as a mobile station (user terminal, hereinafter the same). For example, each mode/embodiment of this disclosure may be applied to a configuration in which communication between a base station and a mobile station is replaced with communication between multiple mobile stations (For example, it may be called Device-to-Device (D2D), Vehicle-to-Everything (V2X), etc.). In this case, the mobile station may have the function of the base station. In addition, words such as “up” and “down” may be replaced with words corresponding to communication between terminals (For example, “side”). For example, terms an uplink channel, a downlink channel, or the like may be read as a side channel.

Similarly, mobile stations in this disclosure may be replaced with base stations. In this case, the base station may have the function of the mobile station.

A radio frame may consist of one or more frames in the time domain. Each one or more frames in the time domain may be referred to as a subframe.

A subframe may further consist of one or more slots in the time domain. A subframe may have a fixed length of time (For example, 1 ms) independent of numerology.

Numerology may be a communication parameter applied to at least one of the transmission and reception of a signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

Slots may consist of one or more symbols (Orthologous Frequency Division Multiplexing (OFDM)) symbols, Single Carrier Frequency Division Multiple Access (SC-FDMA) symbols, etc., in the time domain. A slot may be a unit of time based on the numerology.

A slot may include a plurality of minislots. Each minislot may consist of one or more symbols in the time domain. A minislot may also be called a subslot. A minislot may be composed of fewer symbols than slots. A PDSCH (or PUSCH) transmitted in units of time larger than the minislot may be referred to as a PDSCH (or PUSCH) mapping type A. A PDSCH (or PUSCH) transmitted using the minislot may be referred to as a PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called the transmission time interval (TTI), multiple consecutive subframes may be called TTI, or one slot or one minislot may be called TTI. That is, at least one of the subframes and TTI may be a subframe (1 ms) in existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

If one slot or one minislot is called a TTI, one or more TTIs (That is, one or more slots or one or more minislots) may be the minimum unit of time for scheduling. In addition, the number of slots (number of minislots) constituting the minimum unit of time for scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTIs that are usually shorter than TTI may be called shortened TTI, short TTI, partial or fractional TTI, shortened subframe, short subframe, minislot, subslot, slot, etc.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

A resource block (RB) is a resource allocation unit in the time and frequency domains, and may include one or more consecutive subcarriers in the frequency domain. The number of subcarriers included in RB may be, for example, twelve, and the same regardless of the topology. The number of subcarriers included in the RB may be determined based on the neurology.

The time domain of the RB may also include one or more symbols, and may be one slot, one minislot, one subframe, or one TTI long. One TTI, one subframe, and the like may each consist of one or more resource blocks.

One or more RBs may be referred to as Physical RB (PRB), Sub-Carrier Group (SCG), Resource Element Group (REG), PRB pair, RB pair, and the like.

A resource block may also consist of one or more Resource Elements (REs). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be identified by an index of RBs with respect to the common reference point of the carrier. PRB may be defined in BWP and numbered within that BWP.

BWP may include UL BWP (UL BWP) and DL BWP (DL BWP). For the UE, one or more BWPs may be set within one carrier.

At least one of the configured BWPs may be active, and the UE may not expect to transmit and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, configurations such as the number of subframes contained in a radio frame, the number of subframes or slots per radio frame, the number of minislots contained in a slot, the number of symbols and RBs contained in a slot or minislot, the number of subcarriers contained in an RB, and the number of symbols, symbol length, and Cyclic Prefix (CP) length in a TTI can be varied variably.

The terms “connected,” “coupled” or any variation thereof mean any connection or combination, directly or indirectly, between two or more elements and may include the presence of one or more intermediate elements between two elements that are “connected” or “coupled” to each other. The connection or connection between elements may be physical, logical or a combination thereof. For example, “connection” may be read as “access.” As used in this disclosure, the two elements may be considered to be “connected” or “coupled” to each other using at least one of one or more electric wires, cables and printed electrical connections and, as some non-limiting and non-comprehensive examples, electromagnetic energy with wavelengths in the radio frequency domain, the microwave domain and the optical (both visible and invisible) domain.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to elements using designations such as “first” or “second” as used in this disclosure does not generally limit the amount or order of those elements. Such designations can be used in the present disclosure as a convenient way to distinguish between two or more elements. Thus, references to the first and second elements do not imply that only two elements can be adopted there or that the first element must in some way precede the second.

In the present disclosure, the used terms “include,” “including,” and variants thereof are intended to be inclusive in a manner similar to the term “comprising.” Furthermore, the term “or (or)” as used in this disclosure is not intended to be an exclusive OR.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” and “determination” may include regarding some action as “judgment” and “determination.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 NG-RAN
100 gNB
200 UE
210 radio signal transmission and reception unit
220 amplifier unit
230 modulation and demodulation unit
240 control signal and reference signal processing unit
250 encoding/decoding unit
260 data transmission and reception unit
270 control unit
1001 processor
1002 memory
1003 storage
1004 communication device
1005 input device
1006 Output Device
1007 Bus

1. A terminal comprising:
a transmission unit that transmits a random access preamble as the first message; and
a reception unit that receives a response message to the first message as the second message;
wherein
the transmission unit transmits a third message via a physical uplink shared channel, after receiving the second message, and
the transmission unit performs a repetitive transmission of the third message based on downlink control information.

2. The terminal of claim 1, wherein
the transmission unit performs the repetitive transmission of the third message based on announcement information containing information elements about the repetitive transmission and the downlink control information.

3. The terminal of claim 1, wherein
the transmission unit performs the repetitive transmission of the third message based on the second message.

4. (canceled)

5. (canceled)

6. The terminal of claim 2, wherein
the transmission unit performs the repetitive transmission of the third message based on the second message.

7. The terminal of claim 3, wherein
the transmission unit performs the repetitive transmission of the third message based on announcement information containing information elements about the repetitive transmission and the second message.

8. The terminal of claim 1, wherein
the transmission unit applies an inter-slots frequency hopping during the repetitive transmission of the third message.

9. A base station comprising:
a reception unit that receives a random access preamble as the first message; and
a transmission unit that transmits a response message to the first message as the second message;
wherein
the reception unit receives a third message via a physical uplink shared channel, after transmitting the second message, and
the reception unit performs a repetitive reception of the third message based on downlink control information.

10. A radio communication system comprising:
a terminal; and
a base station;
wherein
the terminal transmits a random access preamble as the first message,
the base station transmits a response message to the first message as the second message,
the terminal transmits a third message via a physical uplink shared channel, after receiving the second message, and
the terminal performs a repetitive transmission of the third message based on downlink control information.

11. A radio communication method comprising:
a step A of transmitting a random access preamble as the first message;
a step B of receiving a response message to the first message as the second message; and
a step C of transmitting a third message via a physical uplink shared channel, after receiving the second message;
wherein the step C includes a step of performing a repetitive transmission of the third message based on downlink control information.
